(19) United States
(12) Patent Application Publication
(10) Pub. No.: US 2025/0230782 A1
(43) Pub. Date: Jul. 17, 2025

(54) Eductor Jet Engine

(71) Applicant: Peter Mark Evans, Bay Harbor Islands, FL (US)

(72) Inventor: Peter Mark Evans, Bay Harbor Islands, FL (US)

(21) Appl. No.: 18/410,069

(22) Filed: Jan. 11, 2024

(51) Int. Cl. F02K 1/36; F02C 6/20; F02C 7/04; F02K 3/00

(52) U.S. Cl. CPC F02K 1/36; F02C 6/20; F02C 7/04; F02K 3/00

(57) ABSTRACT

An electrically powered eductor jet engine that utilizes plasma generation to provide jet propulsion. The jet engine may include at least one eductor shroud containing a positive plasma generator and a negative plasma generator. Additionally, shrouds of the eductor jet engine contain vortex compression tubes which house high voltage generator boost step-up inverter arc pulse generators. Furthermore, the system is powered by a power source such as an air powered electric generator such that the propellant supply, being air, provides power to the system as it is expelled.

### FIELD OF THE INVENTION

The present invention relates generally to a jet engine. More specifically, the present invention is an electrically powered eductor plasma jet engine.

### BACKGROUND OF THE INVENTION

Traditional jet engines rely on the combustion of fossil fuels to produce high-velocity exhaust gases for propulsion. These engines are associated with environmental concerns and limited efficiency. The present invention seeks to address these issues by introducing a unique approach to propulsion. Currently, various types of jet propulsion and plasma jet propulsion are known within the prior art, however the present invention seeks to address the pitfalls of such by generating environmentally safe jet propulsion. The prior art requires the use of aircraft fuel or the like to cause the generation of power to occur via combustion or ion generators.

Even though turbine jet engines are highly effective at generating thrust, there are known inefficiencies associated with the operation, such as the amount of fuel turbine jet engines use which is not good for the environment especially having to burn more fuel to achieve the maximum thrust needed during acceleration for an aircraft to take-off, and/or during compensation for an engine-out situation of the aircraft. Operational efficiency is only achieved at cruise or constant speeds as another example, during deceleration, potential kinetic energy of the aircraft may be lost during descent of the aircraft, potential kinetic energy is generally not recovered and represents a loss of energy that initially was utilized to accelerate the aircraft and/or to attain a given altitude, respectively. The Bernoulli principle electric jet engine refers to a type of propulsion system that utilizes the principles of fluid dynamics, specifically the Bernoulli's principle, to generate thrust without the use of traditional combustion engines.

The objective of the present invention is to provide environmentally safe jet propulsion. According to Bernoulli's principle, as the speed of a fluid (such as air or water) increases, the pressure decreases. This principle forms the basis for the generation of lift in aircraft wings or boat foils and can also be applied to propulsion systems. Instead of relying on combustion, a Bernoulli principle electric jet engine would be powered by electricity. Electric motors and turbines would drive the system to compress and accelerate air into a high-pressure air flow. The present invention would provide an electric motor and turbine to accelerate the fluid, typically air, within the engine. This acceleration would create a pressure differential, with lower pressure at the exit or nozzle of the engine. The pressure differential created by the fluid acceleration would generate thrust, propelling the aircraft or vehicle forward. This thrust is a result of the interaction between the high-speed fluid and the surrounding atmosphere.

### SUMMARY OF THE INVENTION

An electrically powered eductor jet engine that utilizes plasma generation to provide jet propulsion. The jet engine may include at least one eductor shroud containing a positive plasma generator and a negative plasma generator. Additionally, shrouds of the eductor jet engine contain vortex compression tubes which house high voltage generator boost step-up inverter arc pulse generators. Furthermore, the system is powered by a power source such as an air powered electric generator such that the propellant supply, being air, provides power to the system as it is expelled.

### BRIEF DESCRIPTION OF THE DRAWINGS

FIG. 1 is a system diagram of the present invention.

FIG. 2 is a section view of the present invention.

FIG. 3 is a component diagram of the turbine shroud.

FIG. 4 is a component diagram of the first eductor shroud.

FIG. 5 is a diagram of a high voltage generator boost step-up inverter arc pulse generator.

FIG. 6 is a component diagram of the second eductor shroud.

FIG. 7 is a component diagram of the third eductor shroud.

FIG. 8 is a component diagram of the steering control system.

FIG. 9 is a side view of the steering control.

FIG. 10 is a diagram of the eductor jet engine showing thrust vectoring.

FIG. 11 is a component diagram of the eductor jet engine the propellant supply and power source.

FIG. 12 is a diagram of the power sources of the present invention.

FIG. 13 is a perspective view of the air powered electric generator.

FIG. 14 is a perspective view of an alternative embodiment of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

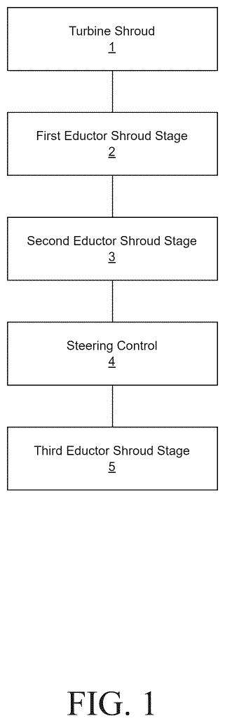

The present disclosure includes many aspects and features. Moreover, while many aspects and features relate to, and are described in the context of an eductor jet engine, referred herein via FIGS. 1-14, embodiments of the present disclosure are not limited to use only in this context.

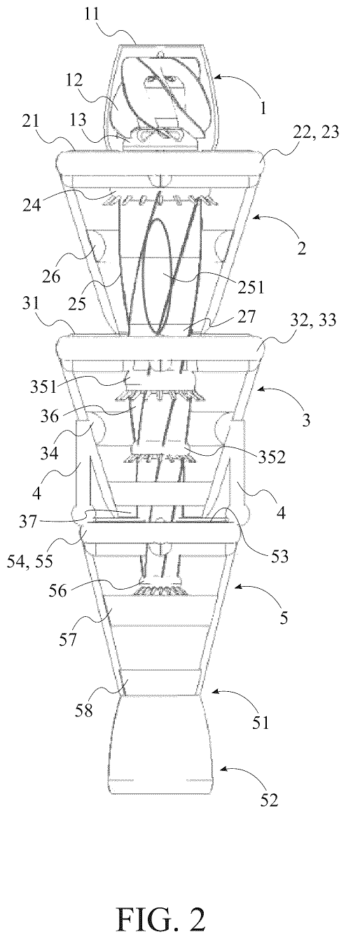

As shown in FIG. 1 and FIG. 2, the present invention is an eductor jet engine comprising a turbine shroud 1 and an at least one eductor shroud. In the preferred embodiment of the present invention, the present invention comprises a first eductor shroud 2, a second eductor shroud 3, and a third eductor shroud 5. As shown in FIG. 2, the turbine shroud 1 is adjacent to the first eductor shroud 2, the first eductor shroud 2 is further adjacent to the second eductor shroud 3, and the second eductor shroud 3 is further adjacent to the third eductor shroud 5. In the context of the present invention, the ordinal numbers such as “first,” “second,” and “third,” are used in the context to differentiate between like components and are not to be limited as to require specific placement of said components unless otherwise specified. Additionally, as shown in FIG. 1 and FIG. 2, the present invention further comprises a steering control 4. In the preferred embodiment of the present invention, the steering control 4 is coupled to the eductor shroud that comprises a thrust diffuser 52. In the preferred embodiment, the third eductor shroud 5 comprises the thrust diffuser 52.

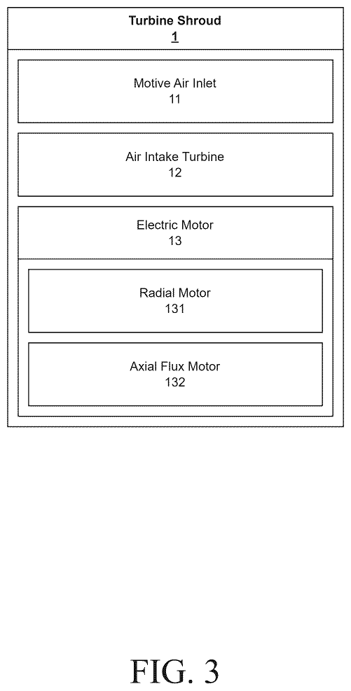

As shown in FIG. 3, the turbine shroud 1 comprises a motive air inlet 11, an air intake turbine 12, and an electric motor 13. The motive air inlet 11 is an opening in the turbine shroud 1 composing a leading edge of the turbine shroud 1. Furthermore, the air intake turbine 12 and the electric motor 13 are housed within the turbine shroud 1. In some embodiments of the present invention, the electric motor 13 is a radial motor 131. Contrarily, in some embodiments of the present invention, the electric motor is an axial flux motor 132. Although a radial motor 131 and an axial flux motor 132 have been shown and described herein, the present invention is not limited to such electric motors. The electric motor 13 drives the air inlet turbine 12, thus creating a naturally and mechanically produced air flow into the motive air inlet 11.

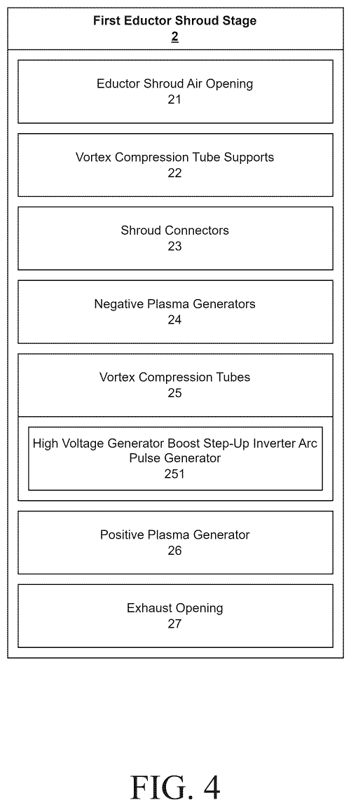

As shown in FIG. 4, the first eductor shroud 2 comprises an eductor shroud air opening 21 and an exhaust opening 27. In the context of the present invention, the eductor shroud air opening 21 and an exhaust opening 27 of the first eductor shroud 2 comprise opposite distal ends of said eductor shroud 2, wherein the eductor shroud air opening 21 composes a leading edge of the first eductor shroud 2 and the exhaust opening 27 composes a trailing edge of the first eductor shroud 2. The first eductor shroud 2 further comprises a vortex compression tube support 22, a shroud connector 23, a negative plasma generator 24, a plurality of vortex compression tubes 25, and a positive plasma generator 26. The shroud connector 23 of the first eductor shroud 2 couples the turbine shroud 1 to the leading edge of the first eductor shroud 2.

Additionally, in the preferred embodiment of the present invention, an electrical discharge corona ion generator, also referred to herein as a corona discharge ionizer, compose each of the positive and negative plasma generators. The positive plasma generator refers to a corona discharge ionizer that produces positive ions in an airstream to create plasma. The negative plasma generator refers to a corona discharge ionizer that produces negative ions in an airstream to create plasma.

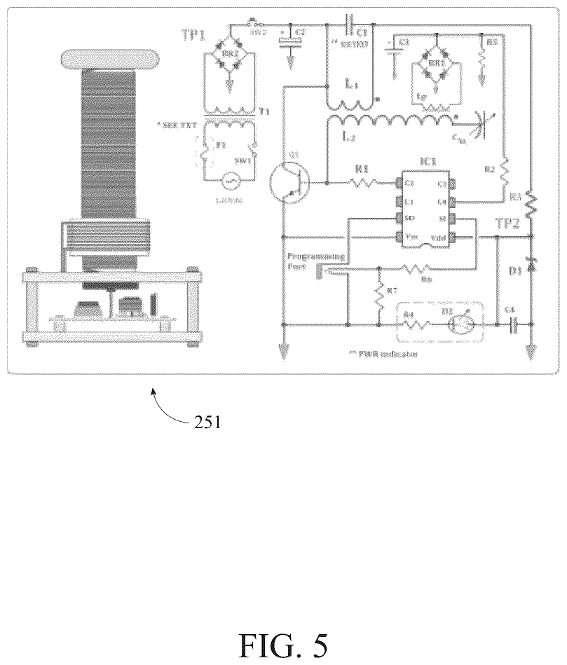

Furthermore, the negative plasma generator 24, the plurality of vortex compression tubes 25, and the positive plasma generator 26 are contained within the first eductor shroud 2. In the preferred embodiment of the present invention, the vortex compression tube support 22 secures the plurality of vortex compression tubes 25 within the eductor jet engine. In the context of the present invention, the plurality of vortex compression tubes 25 are structures traversing a majority portion of the eductor jet engine, compressing a vortexed airstream into a converging section. In the preferred embodiment of the present invention, as shown in FIG. 4, the plurality of vortex compression tubes 25 encase a high voltage generator boost step-up inverter arc pulse generator 251. In the context of the present invention, the high voltage generator boost step-up inverter arc pulse generator 251 is composed of tesla coils and an electric circuit, as shown in FIG. 5, which aid in producing heat and thrust. The high voltage generator boost step-up inverter arc pulse generator 251 further increases the power output needed to excite the ionization.

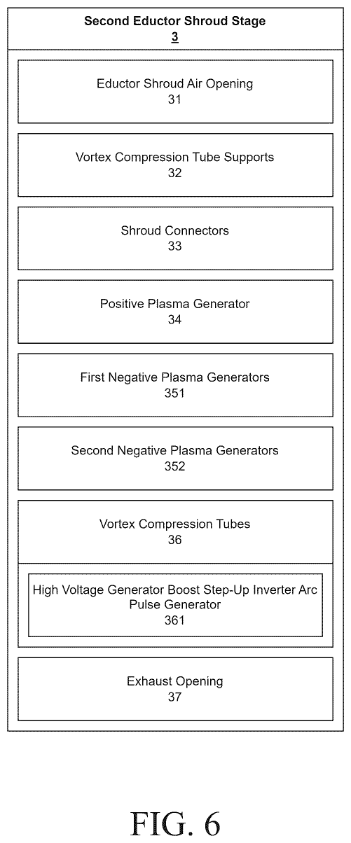

As shown in FIG. 6, the second eductor shroud 3 comprises an eductor shroud air opening 31 and an exhaust opening 37. In the context of the present invention, the eductor shroud air opening 31 and an exhaust opening 37 of the second eductor shroud 3 comprise opposite distal ends of said eductor shroud 3, wherein the eductor shroud air opening 31 composes a leading edge of the second eductor shroud 3 and the exhaust opening 37 composes a trailing edge of the second eductor shroud 3. Similarly to the first eductor shroud 2, the second eductor shroud 3 comprises a vortex compression tube support 32, a shroud connector 33, a positive plasma generator 34, and a plurality of vortex compression tubes 36. Furthermore, the second eductor shroud 3 further comprises a first negative plasma generator 351 and a second negative plasma generator 352. Moreover, contained within the plurality of vortex compression tubes 36, the second eductor shroud 3 further comprises a high voltage generator boost step-up inverter arc pulse generator 361. Additionally, the shroud connector 33 of the second eductor shroud 3 couples the first eductor shroud 2 to the second eductor shroud 3 whereby the exhaust opening 27 of the first eductor shroud 2 is adjacent to the eductor shroud air opening 31 of the second eductor shroud 3.

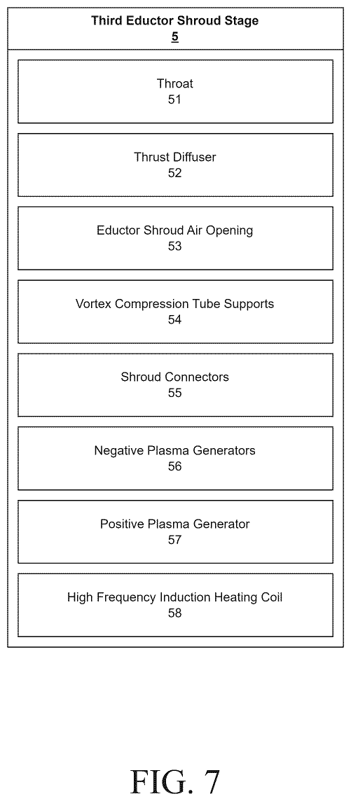

The third eductor shroud 5, as shown in FIG. 7, comprises a throat 51, a thrust diffuser 52, and an eductor shroud air opening 53. In the context of the present invention, the eductor shroud air opening 53 and the thrust diffuser 52 of the third eductor shroud 5 comprise opposite distal ends of said eductor shroud 5, wherein the eductor shroud air opening 53 composes a leading edge of the third eductor 5 shroud and the thrust diffuser 52 composes a trailing edge of the third eductor shroud 5. The throat 51 is interposed at a position in between the eductor shroud air opening 53 and the thrust diffuser 52 of the third eductor shroud 5. Furthermore, the third eductor shroud 5 comprises a high frequency induction heating coil 58 proximate the throat 51. As understood by one of ordinary skill in the art, a high frequency induction heating coil provides a high voltage for electrical discharges in gases at low pressure.

The third eductor shroud 5, as shown in FIG. 7, further comprises a vortex compression tube support 54, a shroud connector 55, a negative plasma generator 56, and a positive plasma generator 57. The compression tube support 54 of the third eductor shroud 5 secures the portion of the plurality of vortex compression tubes traversing the third eductor shroud, within the shroud 5. Moreover, the shroud connectors 55 of the third eductor shroud 5 couple the third eductor shroud 5 to the second eductor shroud 3 whereby the exhaust opening 37 of the second eductor shroud 3 is adjacent to the eductor shroud air opening 53 of the third eductor shroud 5.

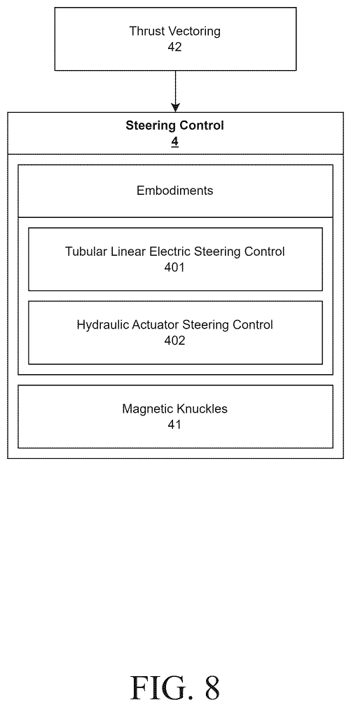

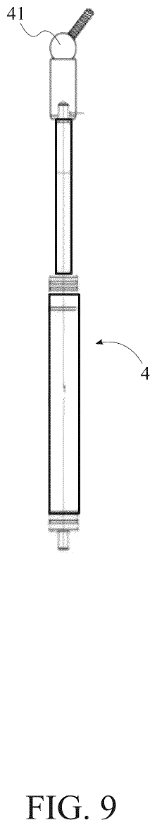

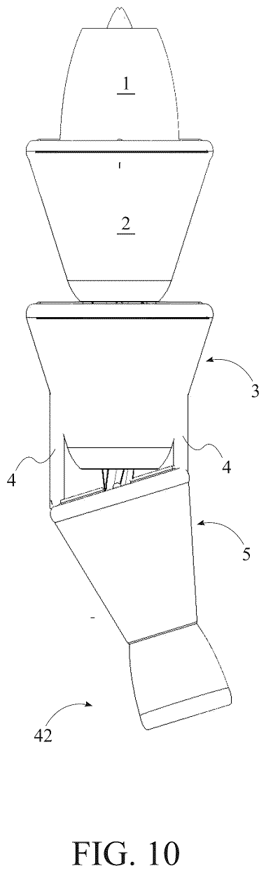

As shown in FIG. 8 and FIG. 9, the steering control 4 of the present invention comprises magnetic knuckles 41. In the context of the present invention, the magnetic knuckles 41 are joints that permit rotation of the steering control 4. The steering control 4 is coupled to the eductor shroud comprising the thrust diffuser 52 and the adjacent shroud. In some embodiments of the present invention, as shown in FIG. 8, the steering control 4 is a tubular linear electric steering control system 401. In alternative embodiments of the present invention, the steering control 4 is a hydraulic actuator steering control system 402. In the preferred embodiment of the present invention, the steering control 4 is coupled to the second and third eductor shrouds 3, 5. The steering control 4 manipulates the direction in which the thrust diffuser 52 is pointed, thus creating a thrust vectoring system 42. The thrust vectoring 42 system refers to the ability of the present invention to manipulate the thrust vector 42, and thus the direction of propulsion of the eductor jet engine, as shown in FIG. 10. Furthermore, in some embodiments of the present invention may further utilize a combustible chemical to increase thrust.

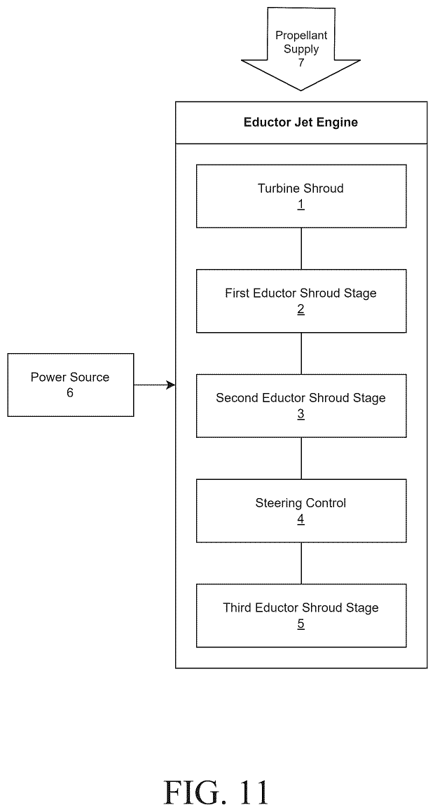

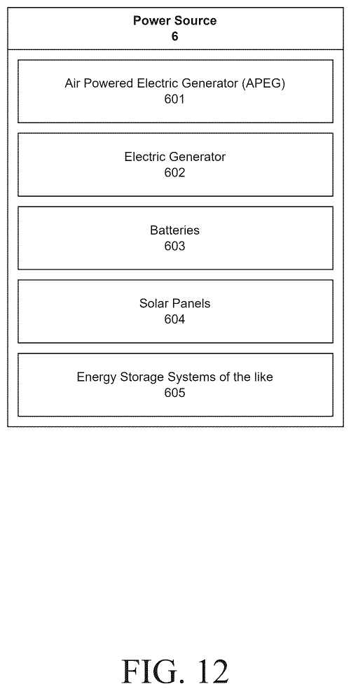

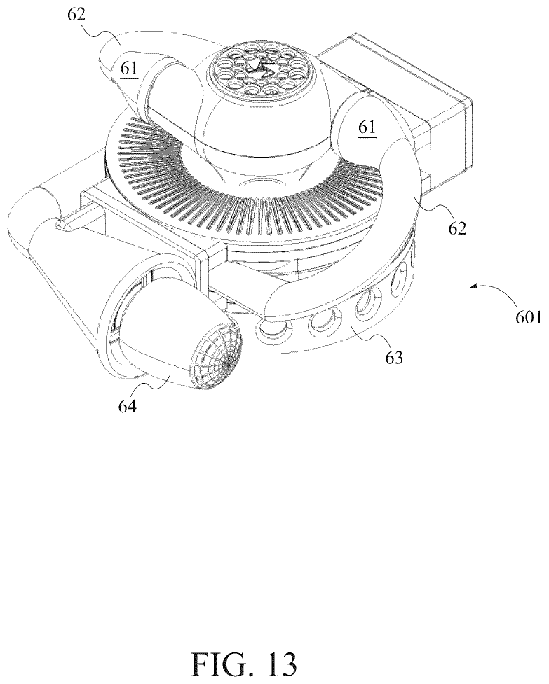

In the preferred embodiment of the present invention, as shown in FIG. 11, the present invention further comprises a power source 6 and a propellant supply 7. In the context of the present invention, the propellant supply 7 refers to air, gas, propellant cartridges, and fluids of the like to provide material for ionization. Furthermore, as shown in FIG. 12 the power source 6 may be chosen from one of the sources such as an air powered electric generator (APEG) 601, an electric generator 602, a battery 603, a solar cell such as a solar panel 604, and energy storage systems of the like 605. In the preferred embodiment of the present invention, the power source is an APEG 601. As shown in FIG. 13, the APEG comprises an air intake turbine 61, an air manifold 62, a vented base 63, and a battery 64.

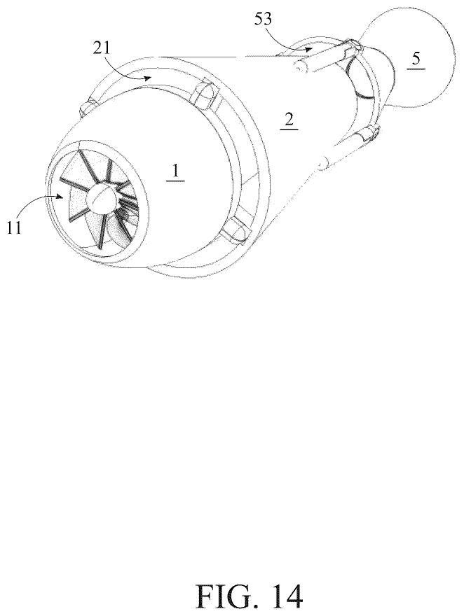

Although an eductor jet engine comprising three eductor shrouds has been shown and described, the present invention is not limited to such, as shown by the embodiment of the present invention in FIG. 14. In alternative embodiments, the present invention may comprise at least one eductor shroud, including a plurality of eductor shrouds. Additionally, as previously stated and although an eductor jet engine utilizing plasma as a source of thrust has been described herein, in some embodiments of the present invention, the eductor jet engine may further utilize a combustible chemical to increase thrust.

Although the invention has been explained in relation to its preferred embodiment, it is to be understood that many other possible modifications and variations can be made without departing from the spirit and scope of the invention.

What is claimed is:

1. An eductor jet engine comprising:
a turbine shroud;
an eductor shroud; and
a propellant source;
the turbine shroud comprising:
a motive air inlet;
an air intake turbine; and
an electric motor;
wherein
the motive air inlet is an opening by which the propellant source enters the eductor jet engine; and
the air intake turbine and the electric motor being housed within the turbine shroud whereby the electric motor drive the air intake turbine;
the eductor shroud comprising a positive plasma generator and a negative plasma generator wherein said plasma generators are housed within the eductor shroud.

2. The eductor jet engine as claimed in claim 1, further comprising:
a throat;
a thrust diffuser;
an eductor shroud air opening; and
a high frequency heating coil;
wherein
the eductor shroud air opening composing a leading edge of the eductor shroud;
the thrust diffuser composing a trailing end of the eductor shroud, opposite the eductor shroud air opening;
the throat interposed between the eductor shroud air opening and the thrust diffuser, whereby the throat is a portion of the eductor shroud comprising a restricted diameter; and
the high frequency heating coil being housed within the eductor shroud, proximate the throat.

3. The eductor jet engine as claimed in claim 2, further comprising:
a vortex compression tube support; and
a shroud connector;
wherein the vortex compression tube support and the shroud connector couple the turbine shroud to the eductor shroud.

4. The eductor jet engine as claimed in claim 1, wherein the electric motor is a radial motor.

5. The eductor jet engine as claimed in claim 1, wherein the electric motor is an axial flux motor.

6. The eductor jet engine as claimed in claim 1 further comprising a steering control;
the steering control coupled to the eductor shroud; and
said steering control comprising a plurality of magnetic knuckles that rotate, thus facilitating thrust vectoring of the eductor jet engine.

7. The eductor jet engine as claimed in claim 6 wherein the steering control is selected from a tubular linear electric steering control and a hydraulic actuator steering control.

8. The eductor jet engine as claimed in claim 1 further comprising an air powered electric generator wherein said air powered electric generator provides a source of power;
the air powered electric generator comprising:
an air intake turbine;
an air manifold;
a vented base; and
a battery.

9. The eductor jet engine as claimed in claim 1, further comprising a power source wherein the power source is selected from an electric generator, an at least one battery, an at least one solar panel; and an energy storage system of the like.

10. The eductor jet engine as claimed in claim 3, further comprising a second eductor shroud interposed between the first eductor shroud and the turbine shroud, wherein the second eductor shroud comprises:
an eductor shroud air opening;
a negative plasma generator;
a positive plasma generator;
a plurality of vortex compression tubes; and
an exhaust opening;
wherein
the eductor shroud air opening of the second eductor shroud composing a leading edge of the second eductor shroud;
the eductor shroud air opening of the second eductor shroud adjacent to the turbine shroud;
the exhaust opening of the second eductor shroud composing a trailing end of the eductor shroud, opposite the eductor shroud air opening of the second eductor shroud;
the exhaust opening of the second eductor shroud adjacent to the eductor shroud air opening of the first eductor shroud; and
the negative plasma generator, the positive plasma generator, and the plurality of vortex compression tubes being housed within the second eductor shroud.

11. The eductor jet engine as claimed in claim 10, further comprising a high voltage generator boost step-up inverter arc pulse generator, wherein said high voltage generator boost step-up inverter arc pulse generator is contained within the plurality of vortex compression tubes.

12. The eductor jet engine as claimed in claim 11 further comprising a third eductor shroud interposed between the first eductor shroud and the second eductor shroud, wherein said third eductor shroud comprises:
an eductor shroud opening;
a positive plasma generator;
a first negative plasma generator;
a second negative plasma generator;
a plurality of vortex compression tubes; and
an exhaust opening;
wherein
the eductor shroud air opening of the third eductor shroud composing a leading edge of the third eductor shroud;
the eductor shroud air opening of the third eductor shroud adjacent to the exhaust opening of the second eductor shroud;
the exhaust opening of the third eductor shroud composing a trailing end of the third eductor shroud, opposite the eductor shroud air opening of the third eductor shroud;
the exhaust opening of the third eductor shroud adjacent to the eductor shroud air opening of the first eductor shroud; and
the first negative plasma generator, the second negative plasma generator, the positive plasma generator, and the plurality of vortex compression tubes being housed within the third eductor shroud.

13. The eductor engine as claimed in claim 12 wherein the plurality of vortex compression tubes of the third eductor shroud comprise a high voltage generator boost step-up inverter arc pulse generator, contained within said plurality of vortex compression tubes.

14. An eductor jet engine comprising:
a turbine shroud;
a first eductor shroud;
a second eductor shroud; and
a propellant source;
the turbine shroud comprising:
a motive air inlet;
an air intake turbine; and
an electric motor;
the first eductor shroud comprising:
an eductor shroud air opening;
a negative plasma generator;
a positive plasma generator; and
an exhaust opening;
the second eductor shroud comprising:
a throat;
a thrust diffuser;
an eductor shroud air opening;
a positive plasma generator; and
a negative plasma generator;
wherein
the first eductor shroud is interposed between the turbine shroud and the second eductor shroud;
the motive air inlet is an opening by which the propellant source enters the eductor jet engine; and
the air intake turbine and the electric motor being housed within the turbine shroud whereby the electric motor drive the air intake turbine;
the eductor shroud air opening and the exhaust opening of the first eductor shroud composing opposing distal ends of said eductor shroud;
the negative plasma generator and the positive plasma generator of the first eductor shroud being contained within said eductor shroud;
the eductor shroud air opening and the thrust diffuser of the second eductor shroud composing opposite distal ends of said eductor shroud;
the throat of the second eductor shroud being interposed between the eductor shroud air opening and the thrust diffuser of said eductor shroud;
the negative plasma generator and the positive plasma generator of the second eductor shroud being contained within said eductor shroud;
the eductor shroud air opening of the first eductor shroud being adjacent to the turbine shroud; and
the exhaust opening of the first eductor shroud being adjacent to the eductor shroud air opening of the second eductor shroud.

15. The eductor jet engine as claimed in claim 14, wherein:
the first eductor shroud further comprises:
a vortex compression tube support; and
a shroud connector;
wherein
the vortex compression tube support and the shroud connector of the first eductor shroud couple the first eductor shroud to the turbine shroud; and
the second eductor shroud further comprises:
a vortex compression tube support; and
a shroud connector;
wherein
the vortex compression tube support and the shroud connector of the second eductor shroud couple the second eductor shroud to the first eductor shroud.

16. The eductor jet engine as claimed in claim 14, wherein the first eductor shroud further comprises a plurality of vortex compression tubes;
said vortex compression tubes comprising a high voltage generator boost step-up inverter arc pulse generator contained within the vortex compression tubes.

17. The eductor jet engine as claimed in claim 14, further comprising a steering control comprising:
a plurality of magnetic knuckles; and
one system selected from:
a tubular linear electric steering control; and
a hydraulic actuator steering control;
the steering control coupled to the first and second eductor shrouds, facilitating movement of the shrouds and thus manipulating a vector of thrust.

18. The eductor engine as claimed in claim 14, further comprising an air powered electric generator comprising:
an air intake turbine;
an air manifold;
a vented base; and
a battery.

19. An eductor jet engine comprising:
a turbine shroud;
a first eductor shroud;
a second eductor shroud;
a third eductor shroud; and
a propellant source;
the turbine shroud comprising:
a motive air inlet;
an air intake turbine; and
an electric motor;
the first eductor shroud comprising:
an eductor shroud air opening;
a negative plasma generator;
a positive plasma generator; and
an exhaust opening;
the second eductor shroud comprising:
an eductor shroud opening;
a positive plasma generator;
a first negative plasma generator;
a second negative plasma generator;
a plurality of vortex compression tubes; and
an exhaust opening;
the third eductor shroud comprising:
a throat;
a thrust diffuser;
an eductor shroud air opening;
a positive plasma generator; and
a negative plasma generator
wherein
the turbine shroud is adjacent to the first eductor shroud, the first eductor shroud is further adjacent to the second eductor shroud, and the second eductor shroud is further adjacent to the third eductor shroud;
the motive air inlet is an opening by which the propellant source enters the eductor jet engine;
the air intake turbine and the electric motor being housed within the turbine shroud whereby the electric motor drive the air intake turbine;
the eductor shroud air opening and the exhaust opening of the first eductor shroud composing opposing distal ends of said eductor shroud;
the negative plasma generator and the positive plasma generator of the first eductor shroud being contained within said eductor shroud;
the eductor shroud air opening and the exhaust opening of the second eductor shroud composing opposing distal ends of said eductor shroud;
the first negative plasma generator, the second negative plasma generator, and the positive plasma generator of the second eductor shroud being contained within said eductor shroud;
the eductor shroud air opening and the thrust diffuser of the third eductor shroud composing opposite distal ends of said eductor shroud;
the throat of the third eductor shroud being interposed between the eductor shroud air opening and the thrust diffuser of said eductor shroud; and
the negative plasma generator and the positive plasma generator of the third eductor shroud being contained within said eductor shroud.

20. The eductor engine as claimed in claim 19, further comprising an air powered electric generator comprising:
an air intake turbine;
an air manifold;
a vented base; and
a battery.
